(19) United States
(12) Patent Application Publication
(10) Pub. No.: US 2011/0084529 A1
(43) Pub. Date: Apr. 14, 2011

(54) LIFT ASSIST SEAT

(76) Inventor: Chien-Ming HUANG, Taipei (TW)

(21) Appl. No.: 12/686,179

(22) Filed: Jan. 12, 2010

(30) Foreign Application Priority Data
Oct. 12, 2009 (TW) 098218769

(51) Int. Cl. A61G 5/14

(52) U.S. Cl. 297/330

(57) ABSTRACT

A lift assist seat has a base, a cushion, and a chamber formed on the base. A motor capable of rotating both directions, a decelerator for reducing rotation speed of the motor, and a slider driven by the motor to reciprocatively move along a straight line are mounted in the chamber. A raiser is mounted beneath the cushion and has a plurality of support members jacking up the cushion to ascend when the slider is moved toward one direction to drive the support members, or lowering the cushion to descend when the slider is moved toward the other direction, thereby helping users sitting on the cushion to stand up or sit down.

### BACKGROUND OF THE INVENTION

1. Field of the Invention

The present invention is related to a lift assist seat, and more particularly to a lift assist seat aiding sitting and standing by adjusting height of a seat.

2. Description of the Related Art

With reference to FIG. 18, a conventional lift assist seat has a base (91), a cushion (92), a motor (94), a bolt (95) and a horizontal bar (96). The cushion (92) is pivotally mounted on the base (91). The base (91) and the cushion (92) respectively have a pivoting end (911, 921) and a distal end (912, 922) being opposite so that the cushion (92) is pivoted to open or close with respect to the base (91). Two top slide rails (931) and two bottom slide rails (932) are respectively mounted in parallel on the cushion (92) and the base (91). These top and bottom slide rails (931, 932) are longitudinally stretched between the pivoting ends (911, 921) and the distal ends (912, 922) respectively. The motor (94) is mounted on a bottom of the base (91) and abuts the distal ends (912, 922). One end of the bolt (95) is connected with a spindle of the motor (94), and the other end of the bolt (95) abuts the pivoting ends (911, 921). A screw hole (951) is formed through the horizontal bar (96), and the other end of the bolt (95) is screwed in the screw hole (951). Two wheels (961) are respectively mounted on two ends of the horizontal bar (96), and each of the wheels (961) is slid on a corresponding top slide rail (931) and a bottom slide rail (932).

When the motor (94) is operated, the bolt (95) is driven to rotate and the horizontal bar (96) is axially moved along the bolt (95). With reference to FIG. 19, when the horizontal bar (96) is moved toward the pivoting ends (911, 921), the two top slide rails (931) are propped up by the two wheels (961) on the horizontal bar (96) so as to lift the cushion (92). On the other hand, when the horizontal bar (96) is moved toward the distal end (912, 922), the cushion (92) is lowered since it is not propped up by the wheels (961). Accordingly, the lift assist seat aid standing and sitting by controlling the cushion (92) to rise and fall and support weight of a user.

The cushion (92) of the conventional lift assist seat is lifted by using the horizontal bar (96) to prop up the slide rails. Since the moment arm of a force applied to the slide rails (931) by the horizontal bar (96) is gradually shortened when the horizontal bar (96) is approaching the pivoting ends (911, 921), the resulting force propping up the cushion (92) is dropping. When users are heavier, the angle of elevation of the cushion (92) is not high enough, highly depreciating the effect of the conventional lift assist seat in assisting users to stand.

### SUMMARY OF THE INVENTION

An objective of the present invention is to provide a lift assist seat, which is not subjected to the limitation of the weight of user.

To achieve the foregoing objective, the lift assist seat has a base, a cushion, a motor, a controller, a decelerator, a driver and a raiser.

The base has a front end, a rear end and a chamber recessed from the base. The cushion is mounted above the base. The motor is mounted inside the chamber. The controller is mounted inside the chamber and electrically connected with the motor. The decelerator is mounted inside the chamber and driven by the motor, has a main shaft and a gear mounted on the main shaft, and reduces a rotation speed of the motor to output the reduced speed through a main shaft.

The driver has a slider, a first end and a second end and a rack. The slider is mounted inside the chamber. The first end and the second end respectively face the front end and the rear end. The rack is mounted on the driver and is engaged with the gear of the decelerator, and is reciprocatively moved along a straight line.

The raiser is mounted under the cushion and driven by the driver to rise. In collaboration with the common parts mentioned above, different raisers are implemented as follows:

The raiser has a support board and at least one link; one end of the raiser is pivotally connected with the front end of the base; one end of the at least one link is pivotally connected with the second end of the slider, and the other end is pivotally connected with another end of the support board.

The raiser has an upper frame, a lower frame, a first support member, and a second support member; the upper frame and the lower frame respectively have a first end and a second end respectively abutting the front end and the rear end of the base and are mounted at opposite positions located under the cushion and inside the chamber of the base; two upper slideways and two lower slideways are respectively formed on two side peripheries of the upper frame and the lower frame respectively abutting the second ends; each of the slideways is parallel to the moving direction of the slider; a bottom end of the first support member is pivotally mounted to the first end of the lower frame; an upper roller shaft is pivotally connected with a top end of the first support member; a roller is mounted on each end of the upper roller shaft; each roller is located inside a corresponding upper slideway; a top end of the second support member is pivotally connected with the first end of the upper frame; a lower roller shaft is pivotally connected with a bottom end of the second support member; a roller is mounted on each end of the lower roller shaft; each roller is located inside a corresponding lower slideway; the second support member and the first support member are pivotally and crossly connected.

The raiser has an upper frame, a lower frame, at least one first support member, at least one second support member, and at least one third support member; the upper frame and the lower frame respectively have a first end and a second end respectively abutting the front end and the rear end of the base and are mounted at opposite positions located under the cushion and inside the chamber of the base; a top end of the at least one first support member is pivotally connected with the second end of the upper frame and a bottom end thereof is pivotally connected between the first end and the second end of the lower frame; a top end of the at least one second support member is pivotally connected between the first end and the second end of the upper frame and a bottom end thereof is pivotally connected with the first end of the lower frame; a top end of the at least one third support member is pivotally connected with one of the second support members; a bottom end thereof is pivotally connected with a second end of the slider.

The present invention employs the motor to drive the slider to reciprocatively move in a straight line. The support board or the upper frame carrying the cushion is propped up to rise by the slider through the links and the support members. As the moment arms of forces applying to the support board or the upper frame by the links or the support members stay the same, the forces exerted by the motor to prop up the cushion do not drop when the cushion is ascending, thereby effectively solving the insufficient angle of elevation of the cushion when heavier users sitting on the cushion is raised to stand up.

### BRIEF DESCRIPTION OF THE DRAWINGS

FIG. 1 is a perspective view of a first preferred embodiment of a lift assist seat in accordance with the present invention;

FIG. 2 is a partial exploded perspective view in FIG. 1;

FIG. 3 is a perspective view of a base in FIG. 1;

FIG. 4 is an exploded perspective view of a decelerator in FIG. 1;

FIGS. 5 to 7 are perspective views of the first preferred embodiment of the lift assist seat in operation in accordance with the present invention;

FIG. 8 is an exploded perspective view of a second preferred embodiment of a lift assist seat in accordance with the present invention;

FIG. 9 is a perspective view of a driver and an raiser in FIG. 8;

FIG. 10 is a first perspective view of the second preferred embodiment of the lift assist seat in operation in accordance with the present invention;

FIG. 11 is a second perspective view of the second preferred embodiment of the lift assist seat in operation in accordance with the present invention;

FIG. 12 is a third perspective view of the second preferred embodiment of the lift assist seat in operation in accordance with the present invention;

FIG. 13 is an exploded perspective view of a third preferred embodiment of a lift assist seat in accordance with the present invention;

FIG. 14 is a driving unit and an escalating unit in FIG. 13;

FIG. 15 is a first perspective view of the third preferred embodiment of the lift assist seat in operation in accordance with the present invention;

FIG. 16 is a second perspective view of the third preferred embodiment of the lift assist seat in operation in accordance with the present invention;

FIG. 17 is a third perspective view of the third preferred embodiment of the lift assist seat in operation in accordance with the present invention;

FIG. 18 is an cutaway perspective view of a conventional lift assist seat; and

FIG. 19 is a partial cross-sectional view in FIG. 18.

### DETAILED DESCRIPTION OF THE INVENTION

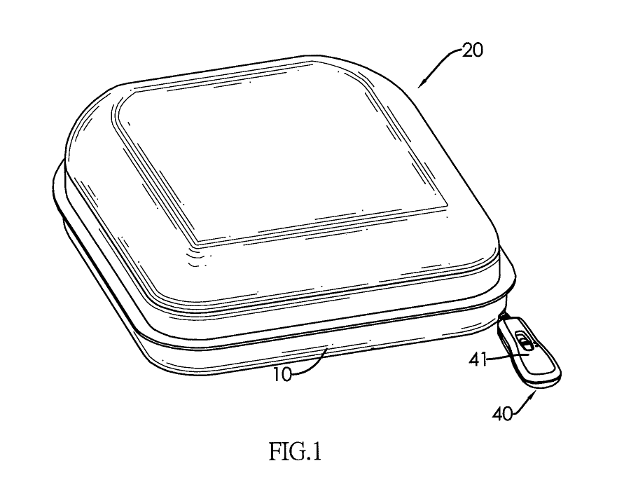

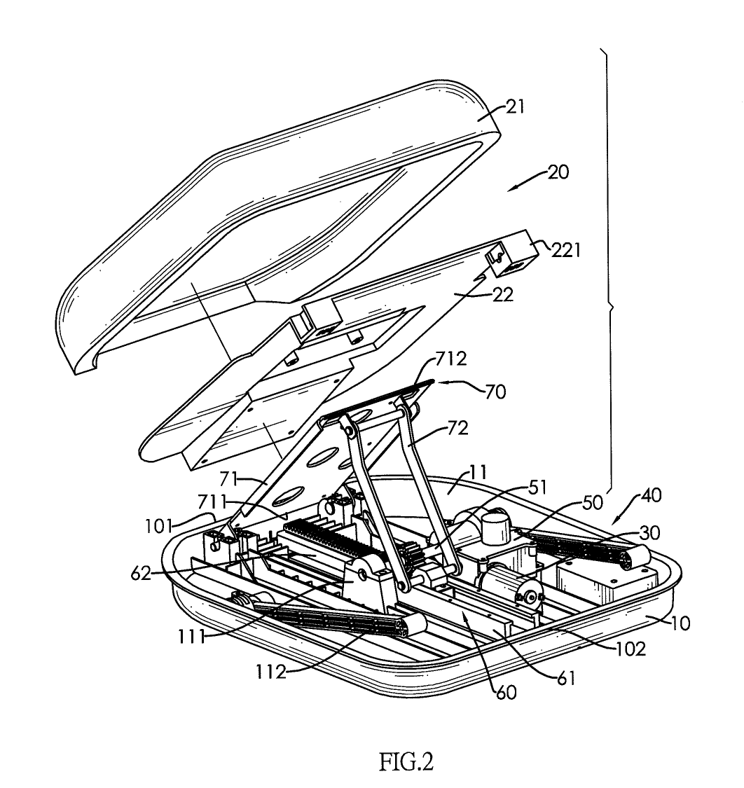

With reference to FIGS. 1 to 3, a lift assist seat of a first preferred embodiment of the present invention has a base (10), a cushion (20), a motor (30), a controller (40), a decelerator (50), a driver (60) and an raiser (70).

The base (10) has a front end (101), a rear end (102), a chamber (11), a bearing block (111) and two drag links (112). The chamber (11) is recessed from the base (10). The bearing block (111) and the two drag links (112) separately located are mounted inside the chamber (11). One bottom end of each of the two drag links (112) is pivotally mounted on the base (10), and the drag links (112) are located between the front end (101) and the rear end (102).

The cushion (20) is mounted above the base (10). The cushion (20) further has a soft seat (21) and a bottom board (22) mounted beneath the soft seat (21). The soft seat (21) and the bottom board (22) are flexible. Two blocks (221) attached underneath two corners of the bottom board (22) and abutting the rear end (102) of the base (10) are pivotally connected with the other ends of the two drag links (112) respectively.

The motor (30) is mounted inside the chamber (11) of the base (10).

The controller (40) is electrically connected with the motor (30) with a cable (not shown) for controlling the motor to rotate clockwise, rotate counterclockwise or stop. The controller (40) further has a circuit board (not shown) mounted inside the chamber (11) of the base (10), and a switch (41) mounted outside the base (10) and electrically connected with the circuit board.

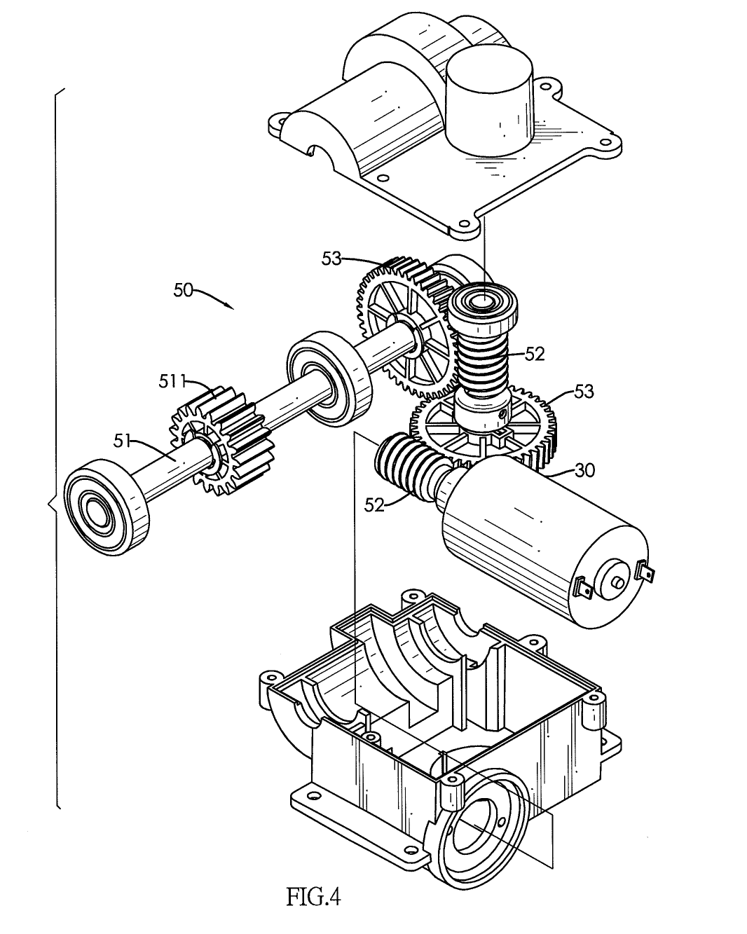

With reference to FIG. 4, the decelerator (50) is mounted inside the chamber (11) of the base (10) and has a main shaft (51), two worms (52), two first gears (53) and a second gear (511). One of the two worms (52) is connected with the motor (30). The other worm (52) is coaxially connected with one of the first gear (53). The other first gear (53) is mounted on the main shaft (51). The two first gears are respectively engaged with the two worms (52) to divert the rotation of the motor (30) to the rotation of the main shaft (51) and reduce the rotation speed of the motor (30). The second gear (511) is mounted on the main shaft (51). Driven by the motor (30), the decelerator (50) slows the rotation speed of the motor (30) and outputs the slowed rotation speed through the main shaft (51). One end of the main shaft (51) is pivotally mounted in the bearing block (111).

The driver (60) has two track guides (61) and a slider (62). The two track guides (61) are mounted in parallel inside the chamber (11) of the base (10). A track (601) is formed within the two track guides (61), and an opening (602) is located above the track (601). The width of the opening (602) is smaller than that of the track (601). The slider (62) is mounted inside the track guides (61) to move back and forth along the track (601), and has a first side (621), a second side (622), a rack (623) and a shaft block (624). The first side (621) and the second side (622) respectively face to the front end (101) and the rear end (102) of the base (10). The rack (623) exposed beyond the opening (602) and the shaft block (624) are mounted on the slider (62). The rack (623) is engaged with the second gear (511). The shaft block (624) is located at the second side (622) of the slider (62).

The raiser (70) is located under the cushion (20) and is driven by the driver (60) to rise. In the first preferred embodiment, the raiser (70) has a support board (71) and at least one link (72). The support board (71) has a first side (711) and a second side (712) being opposite. The first side (711) of the support board (71) is pivotally connected with the front end (101) of the base (10). The support board (71) is fixedly mounted on a bottom portion of the bottom board (22), abutting the front end (101) of the base (10).

One end of each of the at least one link (72) is pivotally connected with the corresponding shaft block (624) of the slider (62), and the other end thereof is pivotally connected with the second side (712) of the support board (71). In the first embodiment, two links (72) are separately mounted.

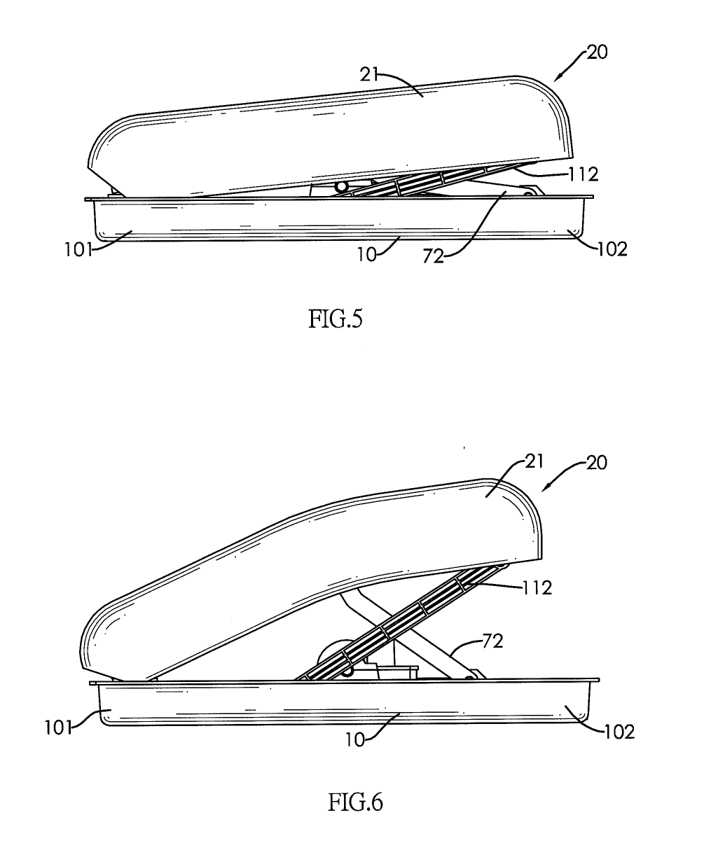

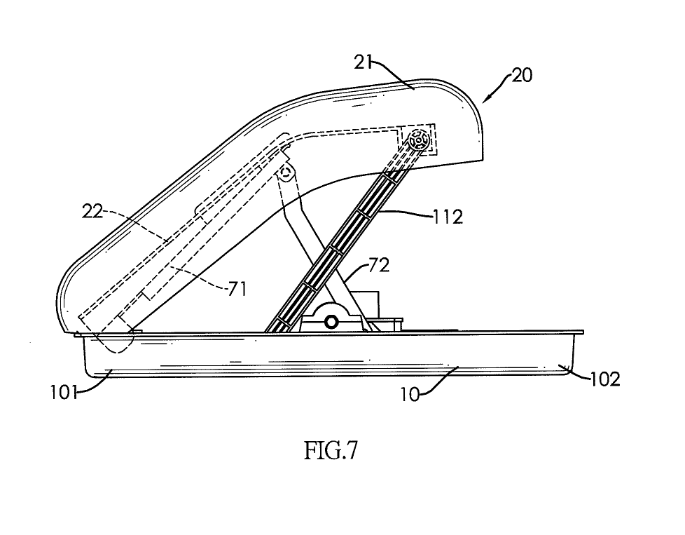

With reference to FIGS. 5 to 7, when intending to ascend the cushion (20), the motor (30) is controlled by the switch (41) to rotate. Power of the motor (30) is transmitted through the decelerator (50) to drive the second gear (511) to rotate. The second gear (511) is further engaged with the rack (623) to drive the slider (62) to move toward the front end (101) of the base (10) so as to support the end of the support board (71) pivotally connected with the at least one link (72) and obliquely position the cushion (20). Therefore, users sitting on the cushion (20) are able to stand up by lifting the cushion (20). Besides, as one end of the bottom board (22) of the cushion (20) is pivotally connected with a top end of each of the drag link (112) and the length of the drag link (112) is less than that of the bottom board (22), the bottom board (22) made of a flexible material is dragged to bend by the drag links (112) having smaller gyration radius. The degree of inclination of the cushion (20) is alleviated, and users are prevented from sliding to the ground. On the other hand, when the slider (62) is controlled to move toward the rear end (102) of the base (10), the cushion (20) is stacked on the base (10) to allow users to sit down.

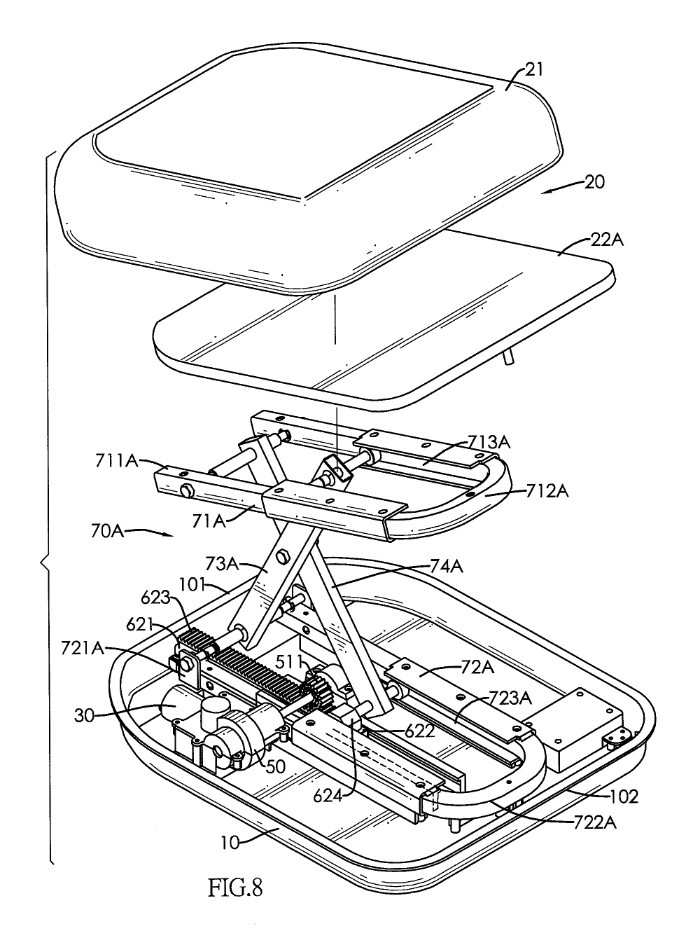

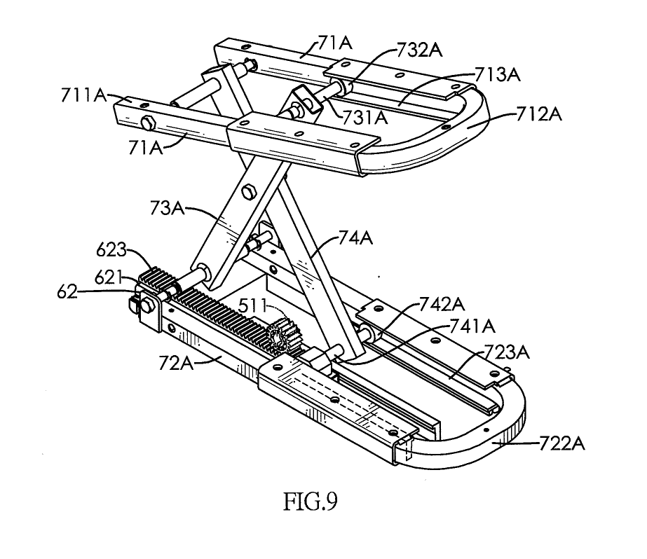

With reference to FIGS. 8 to 9, a raiser (70A) of the second embodiment has an upper frame (71A), a lower frame (72A), a first support link (73A), and a second support link (74A). The upper frame (71A) and the lower frame (72A) respectively have first ends (711A, 721A) and second ends (712A, 722A). The upper frame (71A) and the lower frame (72A) are respectively mounted at opposite positions located under the cushion (20) and inside the chamber (11) of the base (10). The first end (711A, 721A) and the second end (712A, 722A) respectively correspond to the front end (101) and the rear end (102) of the base (10). The upper frame (71A) is fixedly mounted on the bottom board (22A) of the cushion (20). Two upper slideways (713A) and two lower slideways (723A) are respectively formed on two side peripheries of the upper frame (71A) and the lower frame (72A) where abut the second ends (712A, 722A). Each of the slideways (713A, 723A) is parallel to the moving direction of the slider (62).

A bottom end of the first support member (73A) is pivotally mounted to the first end (721A) of the lower frame (72A), and an upper roller shaft (731A) is pivotally connected with a top end of the first support member (73A). A roller (732A) is mounted on each end of the upper roller shaft (731A), and each roller (732A) is located inside a corresponding upper slideway (713A).

A top end of the second support member (74A) is pivotally connected with the first end (711A) of the upper frame (71A), and a lower roller shaft (741A) is pivotally connected with a bottom end of the second support member (74A). A roller (742A) is mounted on each end of the lower roller shaft (741A), and each roller (742A) is located inside a corresponding lower slideway (723A). The second support member (74A) and the first support member (73A) are pivotally and crossly connected. The pivoted place may be located at central portions of the first support member (73A) and the second support member (74A), or at a central portion of the first support member (73A) and between a central portion and a top end of the second support member (74A).

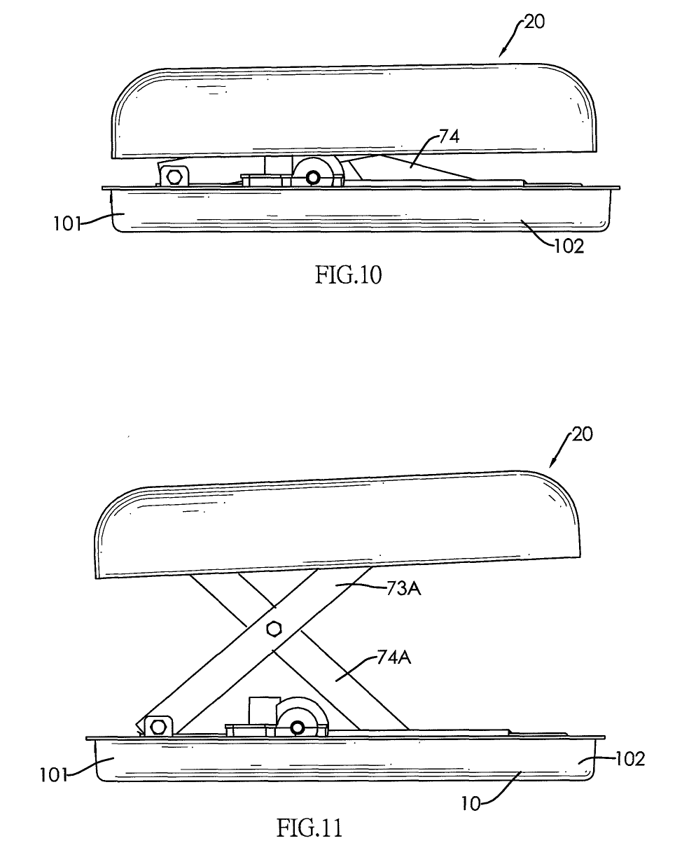

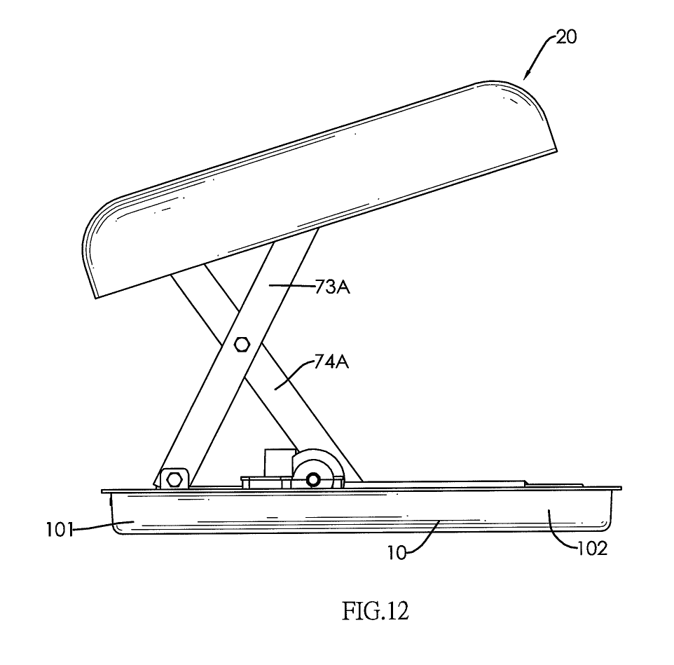

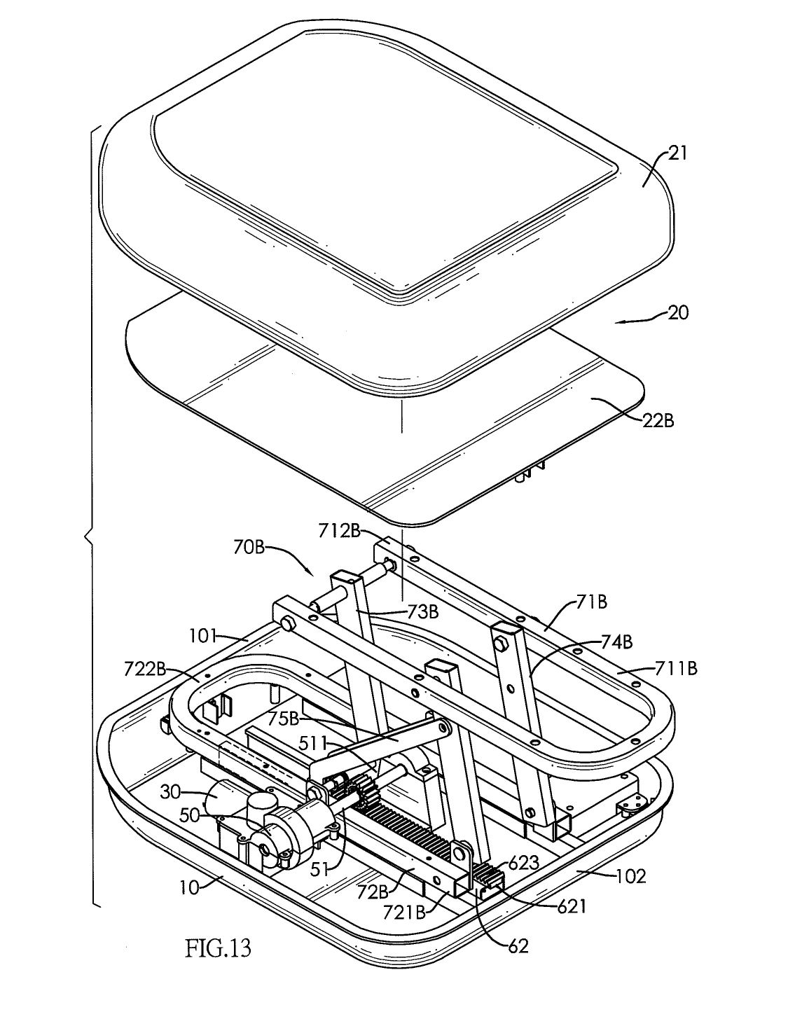

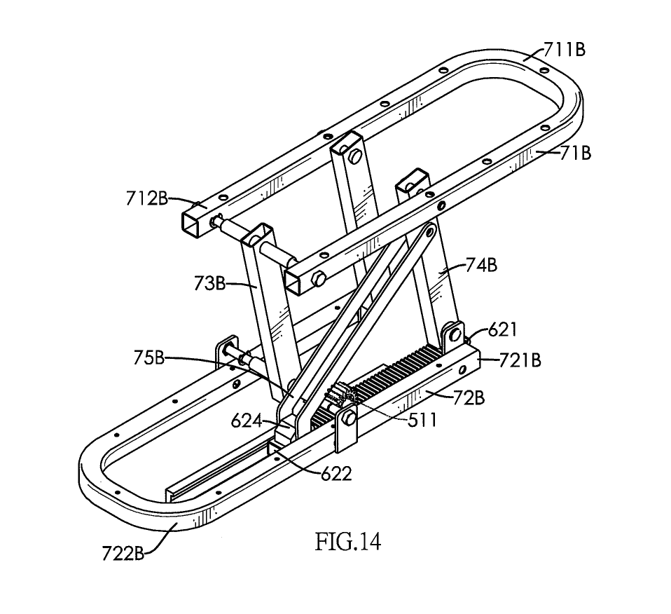

With reference to FIGS. 10 to 12, the raised operation of a cushion (20) of a lift assist seat of the second embodiment in accordance with the present invention is illustrated. The place where the first support member (73A) and the second support member (74A) are pivotally connected is located at the central portion of the first support member (73A) and between the central portion and the upper portion of the second support member (74A). When the slider (62) is moved toward the front end (101) of the base (10), the top end of the second support member (74A) is driven to approach a bottom end of the first support member (73A) by using the rollers (742A) to roll inside the lower slideway (723A). Hence, the top end of the second support member (74A) is raised. As the first support member (73A) and the second support member (74A) are pivotally connected, the top end of the first support member (73A) is also driven to rise. By rolling the rollers (732A) inside the upper slideway (713A) to approach the top end of the second support member (74A), the top ends of the two support members (73A, 74A) can jack up the upper frame (71A). Since the raised height of the top end of the second support member (74A) is lower than that of the top end of the first support member (73A), the cushion (20) is slanted after being raised. Besides, if the central portions of the first support member (73A) and the second support member (74A) are pivotally connected, the cushion (20) is leveled after being raised. With reference to FIGS. 13 to 14, the raiser (70B) of a third embodiment of the present invention has a upper frame (71B), a lower frame (72B), at least one first support member (73B), at least one second support member (74B), and at least one third support member (75B). Each of the upper frame (71B) and the lower frame (72B) has a first end (711B, 721B) and a second end (712B, 722B). The upper frame (71B) and the lower frame (72B) are respectively mounted at opposite positions under the cushion (20) and inside the chamber (11) of the base (10). The first ends (711B, 721B) and the second ends (712B, 722B) respectively correspond to a front end (101) and a rear end (102) of the base (10). The upper frame (71B) is fixedly mounted on a bottom board (22B) of the base (20).

A top end of the at least one first support member (73B) is pivotally connected with the second end (712B) of the upper frame (71B), and a bottom end thereof is pivotally connected between the first end (721B) and the second end (722B) of the lower frame (72B). There is only one first support member (73B) mounted in the third embodiment.

A top end of the at least one second support member (74B) is pivotally connected between the first end (711B) and the second end (712B) of the upper frame (71B), and a bottom end thereof is pivotally connected with the first end (721B) of the lower frame (72B). There are two second support members (74B) mounted in the third embodiment, and the top ends and the bottom ends thereof are pivotally connected with two side peripheries of the upper frame (71B) and the lower frame (72B) respectively.

A top end of the at least one third support member (75B) is pivotally connected with one of the second support members (74B), and a bottom end thereof is pivotally connected with a shaft block (624) of a slider (62). There are two third support members (75B) in the third embodiment, and the top end of the bottom end thereof are pivotally connected with two side peripheries of the second support member (74B) and the shaft block (624) respectively.

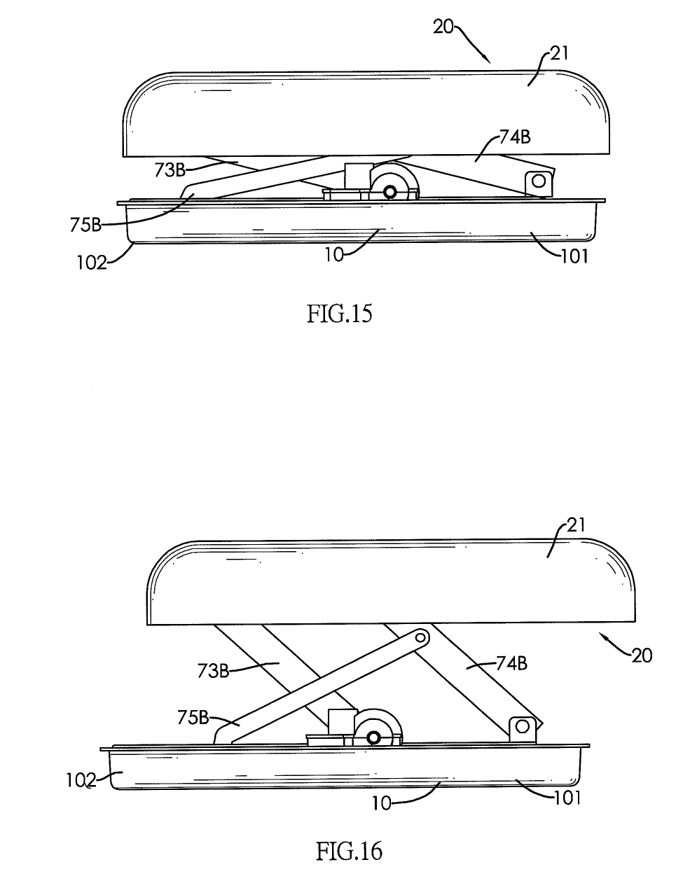

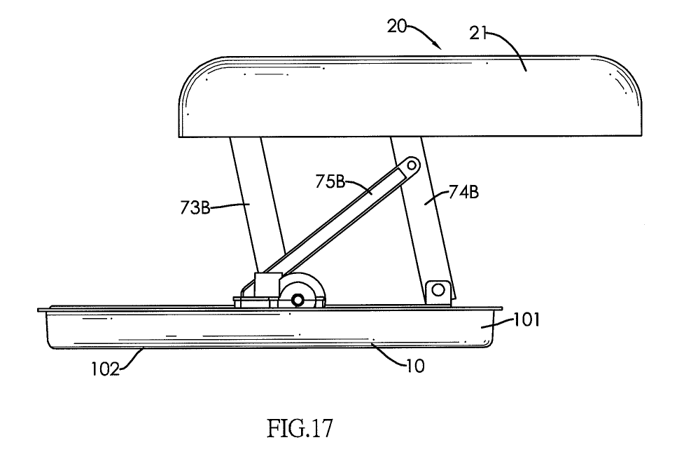

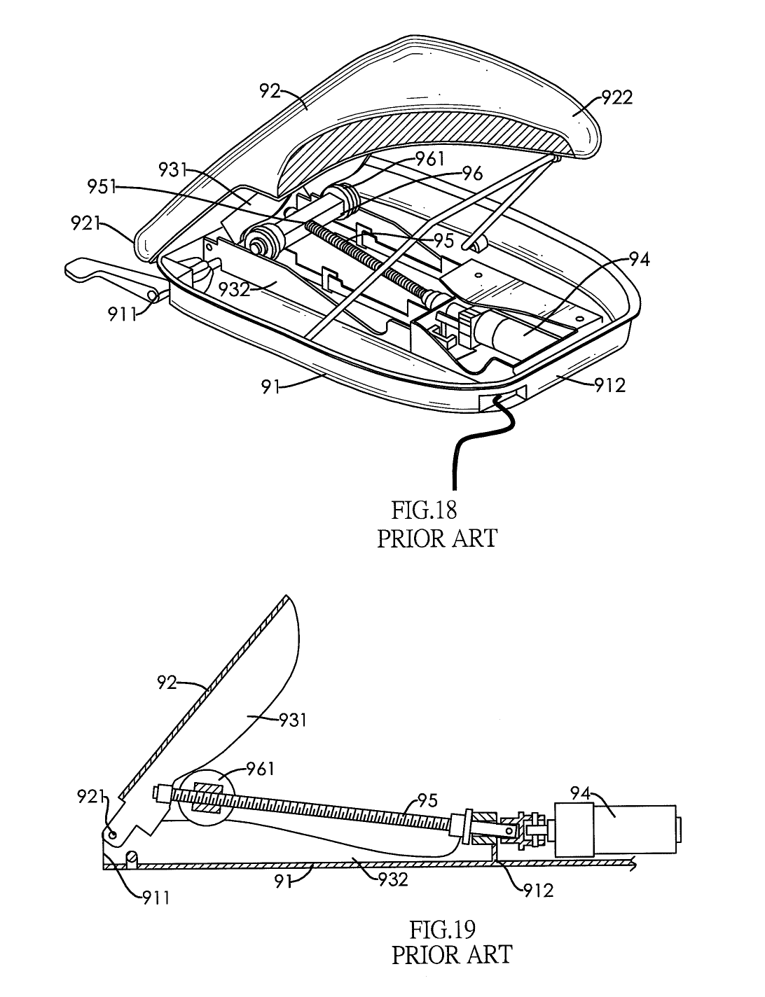

With reference to FIGS. 15 to 17, the raised operation of a cushion (20) of a lift assist seat of the second embodiment in accordance with the present invention is illustrated. When the slider (62) is moved toward the front end of the base (10), the bottom end of the third support member (75B) is driven to approach the bottom end of the second support member (74B), and is raised. As the top end of the third support member (75B) is pivotally connected with the second support member (74B), the second support member (74B) is also driven to swing. By escalating and moving forward the upper frame (71B) driven by the top end of the third support member (75B), the first support member (73B) and the other second support member (74B) are further driven to swing so as to jointly support the upper frame (71B). In the third embodiment, when raised, the cushion (20) is moved forward horizontally.

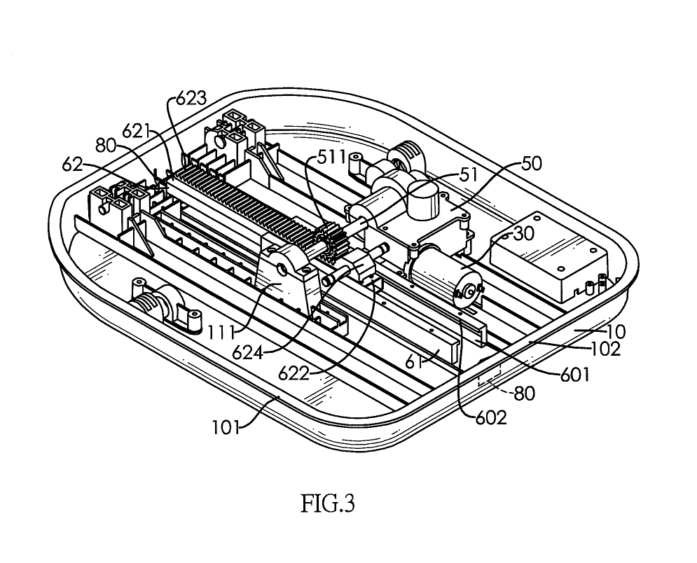

Moreover, with reference to FIG. 3, in all the aforementioned embodiments, two limit switches (80) are further mounted inside the chamber (11) of the base (10). The two limit switches (80) are respectively located at two ends of a movement path of the slider (62) and are electrically connected with the controller (40). Given the limit switches (80), when the slider (62) is moved and one end thereof is contacted with one of the limit switches (80), the limit switch (80) can output a signal to the controller (40). The controller (40) further instructs the motor (30) to reversely rotate. Consequently, when the cushion (20) is ascended or descended to an end point of a stroke of travel, it is automatically descended or ascended in a reverse direction.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A lift assist seat, comprising:
a base having
a front end;
a rear end; and
a chamber recessed from the base;
a cushion mounted above the cushion;
a motor mounted inside the chamber;
a controller mounted inside the chamber and electrically connected with the motor;
a decelerator mounted inside the chamber, driven by the motor, having a main shaft and a gear mounted on the main shaft, and reducing a rotation speed of the motor to output the reduced speed through a main shaft;
a driver having a slider mounted inside the chamber, a first end and a second end respectively facing the front end and the rear end, and a rack mounted thereon and engaged with the gear of the decelerator, and reciprocatively moved along a straight line; and
a raiser having
a support board having a first side and a second side opposite to the first side, the first side thereof pivotally connected with the front end of the base; and
at least one link, one end thereof is pivotally connected with the second end of the slider and the other end pivotally connected with the second side of the support board.

2. The lift assist seat as claimed in claim 1, wherein
two drag links are separately mounted inside the chamber of the base, and a bottom end of each of the two drag links is pivotally connected on the base and is located between the front end and the rear end; and
the cushion further comprises:
a seat made of a flexible material; and
a bottom board mounted on a bottom of the seat, and having two blocks located on two corners of the bottom board, abutting the rear end of the base, and pivotally connected with top ends of the two drag links respectively.

3. The lift assist seat as claimed in claim 2, wherein
the slider further comprises a shaft block mounted thereon and located on the second end thereof; and
one end of the at least one link pivotally connected with the second end of the slider is pivotally connected with the shaft block.

4. The lift assist seat as claimed in claim 3, wherein
the driver further comprises two track guides separately mounted in parallel inside the chamber of the base, surrounding to form a track therein, and an opening located above the track and having a width smaller than that of the track; and
the slider is mounted inside the track guides, and the rack and the shaft block are exposed beyond the opening.

5. The lift assist seat as claimed in claim 4, wherein
the base further has a the bearing block mounted inside the chamber of the base; and
one end of the main shaft of the decelerator is mounted in the bearing block.

6. A lift assist seat, comprising:
a base having
a front end;
a rear end; and
a chamber recessed from the base;
a cushion mounted above the cushion;
a motor mounted inside the chamber;
a controller mounted inside the chamber and electrically connected with the motor;
a decelerator mounted inside the chamber, driven by the motor, having a main shaft and a gear mounted on the main shaft, and reducing a rotation speed of the motor to output the reduced speed through a main shaft;
a driver having a slider mounted inside the chamber, a first end and a second end respectively facing the front end and the rear end, and a rack mounted thereon and engaged with the gear of the decelerator, and reciprocatively moved along a straight line; and
an raiser having
an upper frame;
a lower frame;
a first support member; and
a second support member;
wherein
the upper frame and the lower frame respectively have a first end and a second end respectively abutting the front end and the rear end of the base and are mounted at opposite positions located under the cushion and inside the chamber of the base;
two upper slideways and two lower slideways are respectively formed on two side peripheries of the upper frame and the lower frame respectively abutting the second ends;
each of the slideways is parallel to the moving direction of the slider;
a bottom end of the first support member is pivotally mounted to the first end of the lower frame;
an upper roller shaft is pivotally connected with a top end of the first support member;
a roller is mounted on each end of the upper roller shaft;
each roller is located inside a corresponding upper slideway;
a top end of the second support member is pivotally connected with the first end of the upper frame;
a lower roller shaft is pivotally connected with a bottom end of the second support member;
a roller is mounted on each end of the lower roller shaft;
each roller is located inside a corresponding lower slideway; and
the second support member and the first support member are pivotally and crossly connected.

7. The lift assist seat as claimed in claim 6, wherein
the slider further comprises a shaft block mounted thereon and located on the second end thereof; and
the lower roller shaft passes through the shaft block and is mounted therein.

8. The lift assist seat as claimed in claim 7, wherein
the driver further comprises two track guides separately mounted in parallel inside the chamber of the base, surrounding to form a track therein, and an opening located above the track and having a width smaller than that of the track; and
the slider is mounted inside the track guides, and the rack and the shaft block are exposed beyond the opening.

9. The lift assist seat as claimed in claim 8, wherein
the base further comprises a bearing block mounted inside the chamber of the base; and
one end of the main shaft of the decelerator is mounted in the bearing block.

10. The lift assist seat as claimed in claim 6, wherein the first support member and the second support member are pivotally connected, and the pivoted place is located at central portions of the first support member and the second support member.

11. The lift assist seat as claimed in claim 7, wherein the first support member and the second support member are pivotally connected, and the pivoted place is located at central portions of the first support member and the second support member.

12. The lift assist seat as claimed in claim 8, wherein the first support member and the second support member are pivotally connected, and the pivoted place is located at central portions of the first support member and the second support member.

13. The lift assist seat as claimed in claim 9, wherein the first support member and the second support member are pivotally connected, and the pivoted place is located at central portions of the first support member and the second support member.

14. The lift assist seat as claimed in claim 6, wherein the first support member and the second support member are pivotally connected, and the pivoted place is located at a central portion of the first support member and between a central portion and a top end of the second support member.

15. The lift assist seat as claimed in claim 7, wherein the first support member and the second support member are pivotally connected, and the pivoted place is located at a central portion of the first support member and between a central portion and a top end of the second support member.

16. The lift assist seat as claimed in claim 8, wherein the first support member and the second support member are pivotally connected, and the pivoted place is located at a central portion of the first support member and between a central portion and a top end of the second support member.

17. A lift assist seat, comprising:
a base having
a front end;
a rear end; and
a chamber recessed from the base;
a cushion mounted above the cushion;
a motor mounted inside the chamber;
a controller mounted inside the chamber and electrically connected with the motor;
a decelerator mounted inside the chamber, driven by the motor, having a main shaft and a gear mounted on the main shaft, and reducing a rotation speed of the motor to output the reduced speed through a main shaft;
a driver having a slider mounted inside the chamber, a first end and a second end respectively facing the front end and the rear end, and a rack mounted thereon and engaged with the gear of the decelerator, and reciprocatively moved along a straight line; and
an raiser having
an upper frame;
a lower frame;
at least one first support member;
at least one second support member; and
at least one third support member;
wherein
the upper frame and the lower frame respectively have a first end and a second end respectively abutting the front end and the rear end of the base and are mounted at opposite positions located under the cushion and inside the chamber of the base;
a top end of the at least one first support member is pivotally connected with the second end of the upper frame and a bottom end thereof is pivotally connected between the first end and the second end of the lower frame;
a top end of the at least one second support member is pivotally connected between the first end and the second end of the upper frame and a bottom end thereof is pivotally connected with the first end of the lower frame; and
a top end of the at least one third support member is pivotally connected with one of the second support members, and a bottom end thereof is pivotally connected with a second end of the slider.

18. The lift assist seat as claimed in claim 17, wherein
the slider further comprises a shaft block mounted thereon and located on the second end thereof; and
one end of the at least one third support member pivotally connected with the second end of the slider is pivotally connected with the shaft block.

19. The lift assist seat as claimed in claim 18, wherein
the driver further comprises two track guides separately mounted in parallel inside the chamber of the base, surrounding to form a track therein, and an opening located above the track and having a width smaller than that of the track; and
the slider is mounted inside the track guides, and the rack and the shaft block are exposed beyond the opening.

20. The lift assist seat as claimed in claim 19, wherein
the base further comprises a bearing block mounted inside the chamber of the base; and
two ends of the main shaft of the decelerator are mounted in the bearing block.
